(19) United States
(12) Patent Application Publication
(10) Pub. No.: US 2026/0010983 A1
(43) Pub. Date: Jan. 8, 2026

(54) METHOD AND SYSTEM FOR CORRECTING FIXED-PATTERN NOISE IN AN IMAGE

(71) Applicant: HGH SYSTEMES INFRAROUGES, Igny (FR)

(72) Inventors: Axel DAVY, Palaiseau (FR); Arnaud BARRAL, Vitry-sur-Seine (FR); Anthony THOMAS, Massy (FR); Pablo ARIAS, Barcelona (ES)

(21) Appl. No.: 19/137,114

(22) PCT Filed: Nov. 16, 2023
(86) PCT No.: PCT/EP2023/082076

§ 371 Date: Jun. 9, 2025

(30) Foreign Application Priority Data
Dec. 13, 2022 (FR) FR2213248

(51) Int. Cl. G06T 5/70; G06T 5/50; H04N 23/698

(52) U.S. Cl. CPC G06T 5/70; G06T 5/50; H04N 23/698

(57) ABSTRACT

A method for correcting fixed-pattern noise in at least one image is disclosed. The method includes the following steps:—acquiring at least N substantially distinct and regular images by means of at least one rotating image sensor such that the combination of the N images forms a panorama of a surrounding scene, the fixed-pattern noise in each of the N acquired images being substantially the same;—determining at least one correction parameter for correcting the fixed-pattern noise by means of a processing module from the at least N acquired images, the at least one correction parameter minimizing a functional;—correcting the fixed-pattern noise in each of the N images acquired by the processing module using the at least one determined fixed-pattern noise correction parameter.

### TECHNICAL FIELD

The present invention relates to a method for correcting fixed-pattern noise in at least one image. It also relates to a system for correcting fixed-pattern noise in at least one image.

### PRIOR ART

Although factory-calibrated, infrared cameras are notorious for slight deviations in sensor response. These deviations change slowly over time, from one image to the next. But this change is relatively slow compared to the camera's refresh rate. In the image, these deviations cause a spatially non-uniform response to the same light signal, which appears visually as fixed-pattern noise (FPN) from one image to the next. This noise is typically modeled as having a fixed component and a multiplicative component with respect to the input signal (offsets and gains). Methods for correcting image non-uniformity are known from prior art documents, such as document U.S. Pat. No. 8,503,821. This document proposes to determine the movement of the scene with respect to the sensor between two shots of the same scene, and to use the different pixel responses for the same location in the scene to determine said correction.

Document U.S. Pat. No. 9,900,526 proposes the use of a visual shutter to calibrate a scene. This visual shutter corresponds to an object that appears almost uniform and covers a large part of the camera.

Document U.S. Pat. No. 9,208,542 proposes a method for reducing pixel-level noise in thermal images. This method counts the number of times a pixel is smaller or larger than its neighboring pixels, and corrects the pixel in question accordingly.

The methods in question therefore rely either on the comparison of different views of the same object with different pixel batches, or on the presence of a physical or virtual shutter, or on assumptions of regularity in real images. Methods based on the regularity of real images have the problem that the assumption of regularity is not well verified everywhere in the image. This means that some pixels cannot be correctly corrected from a single image. Methods based on the physical shutter have the disadvantage of not exactly correcting the noise observed in practice. Methods based on the virtual shutter involve a certain logic that is complex to implement. Finally, methods that compare two views of the same object or scene after a movement, or using several sensors, are quite sensitive to the quality of the mapping between the two scenes and the similarity between the images. In addition, the matching algorithm can be computationally expensive.

The aim of the present invention is to resolve at least one of the aforementioned shortcomings.

### DISCLOSURE OF THE INVENTION

This objective is achieved with a method for correcting fixed-pattern noise in at least one image. The method comprises the following steps:
acquiring at least N substantially distinct and regular images by means of at least one rotating image sensor such that the combination of the N images forms a panorama of a surrounding scene, the fixed-pattern noise in each of the N acquired images being substantially the same,
determining at least one correction parameter for correcting the fixed-pattern by means of a processing module from the at least N acquired images, the at least one correction parameter minimizing a functional,
correcting the fixed-pattern noise in each of the N images acquired by the processing module using the at least one determined fixed-pattern noise correction parameter.

Many environmental parameters can affect sensor non-uniformity, such as small temperature variations. This non-uniformity therefore varies over time. However, it can be considered to remain almost fixed with respect to several consecutive images taken at the sensor's maximum frame rate. The correction should therefore be updated frequently.

The present invention relies on several acquired images of different scenes taken with the same image sensor in a short time. This is achieved with a rotating image sensor that can reconstruct a panorama using images taken as the image sensor rotates: each image corresponds to a different piece or sector of the panoramic scene. An acquisition frequency F of the image sensor is higher than a fixed-pattern noise change rate between the acquisition of two images. The acquisition frequency F is sufficient to ensure that any changes in fixed-pattern noise parameters are very small. The invention then avoids the shortcomings of traditional regularity-based methods, as each fixed-pattern noise correction is estimated not from one, but from several acquired images.

It is also assumed that the acquired images are approximately regular over most of the image, and that for each pixel, one or more images can be found among the acquired images that are locally regular around that pixel. “Regular” is understood to mean that the intensity gradient in the image in question does not change abruptly over a majority of the image. An image is also said to be “locally regular” if the pixel values in a small neighborhood can be described with a simple mathematical formula, such as the equation of a plane, with few errors. Natural images are generally considered to be, with high probability, regular in a majority of pixels. This corresponds, for example, to flattened areas of the image, or areas with slight gradations. High-contrast areas, such as the edges of objects, or heavily textured areas, such as a stack of branches, are not considered regular.

Non-uniformity correction parameters can be re-estimated frequently enough to compensate for variations in sensor non-uniformity. “Non-uniformity variations” is understood to mean fixed-pattern noise variations. It is assumed here, in view of the high image acquisition frequency, that the value of the fixed-pattern noise in each image is substantially identical. “Substantially identical” is understood to mean that the fixed-pattern noise has a negligible change between the first and last of the N images acquired.

The at least one fixed-pattern noise correction parameter determined by the processing module according to the invention minimizes a functional of the form

$$E ( O , G ) = {\sum }_{i = 1}^{N} ρ ( {\begin{matrix}f \text{?} & \hat{f}\end{matrix}}_{i} ) + h ( G , O )$$

$$\text{?} \text{indicates text missing or illegible when filed}$$

In this functional, ƒᵢ corresponds to the image i, and \hat{ƒ}ᵢ corresponds to the corrected image i, that is to say

$${\hat{f}}_{i} = G * {f}_{i} + O$$

where G, O and ƒᵢ are image-size matrices, and * is the Hadamard product. G and O correspond to a gain and offset matrix, respectively.

The values of the O and G matrices are the parameters that are estimated.

A variable number of parameters can be determined from the N images acquired. In the case where only O is estimated, the invention gives more robust and rapid results. When several parameters are estimated, the signal is better represented and the correction is more effective in practice. The values of the O and G matrices are the parameters that are estimated in this case.

The step of determining at least one fixed-pattern noise correction parameter by means of the processing module may comprise the following step:
determining a set of at least two correction parameters for the set of N images acquired by the processing module, the set of correction parameters comprising a gain value and an offset value.

To minimize the functional, a set of two parameters is determined directly from the N images acquired. The set of N images are taken into account to determine the parameter set. In this embodiment, the functional can be defined by:

$$( a , b ) = TV ( b )$$

$$and$$

$$h ( G , O ) = {‖ O ‖}_{ℱ}^{2} + {‖ G - 1 ‖}_{ℱ}^{2}$$

The step of determining at least one fixed-pattern noise correction parameter by means of the processing module can be carried out via a direct implementation.

The direct implementation may comprise the following steps:
first filtering of the N images,
second filtering along the N images.

Advantageously, the first filtering of the N images may comprise the use of a high-pass filter.

A judicious choice of [symbol] and h allows for a direct implementation, where a succession of filtering operations can be used to directly obtain the minimum of the functional. At least one correction parameter can be determined in this way. In one embodiment, the judicious choice of [symbol] and h corresponds to

$$( a , b ) = {‖ F ( a ) ˇ a + b ‖}_{1}$$

This results in

$$( {\begin{matrix}f \text{?} & \hat{f}\end{matrix}}_{i} ) = {‖ F ( {f}_{i} ) + ( G - \overline{1} ) * {f}_{i} + O ‖}_{1} .$$

$$\text{?} \text{indicates text missing or illegible when filed}$$

where 1̅ is the image size matrix containing 1 in each cell,

where F is a high-pass filter on the acquired image, defined as the subtraction of the median of neighboring pixels from the value of each pixel,

and

h(G, O)=0 if G=1̅ otherwise h(G, O)=+∞

h(G, O)=+∞ forces the gain to be one at each pixel without penalizing the offset value. The functional is then minimized by:

$$O = - {median}_{i = 1 , … , N} F ( {f}_{i} ) and G = \overline{1}$$

where the median operator is understood to be applied independently at each position in the matrix.

A direct implementation of functional minimization then consists firstly in filtering the N images according to the high-pass filter F. The high-pass filter corresponds to a spatial filter. The results of these filtering operations are then filtered by the median operator along the N images.

Other similar functionals have direct implementations. “Direct implementation” is understood to mean that the result of functional minimization is obtained directly without using a functional minimization algorithm.

Using [symbol] ^{(a, b)}= [symbol] has the effect of replacing the median by the mean operator in the direct implementation. A weighted average is obtained using operators [symbol] ; incorporating a different weighting for each image. In the case of the direct implementation using the median operator, we can see the benefit of using norm 1 in [symbol] . In fact, applying the median to the high-pass filter results means that scenes where there is high contrast in the scene, and therefore an aberrant response from the high-pass filter, are not taken into account. The majority of scenes will have a non-erroneous value at this pixel, and this is therefore what the median returns.

The step of determining at least one fixed-pattern noise correction parameter by means of a processing module may also comprise the following step:
temporal smoothing of the at least one correction parameter common to each of the N images acquired.

This temporal smoothing step refines the results of the determined correction parameter(s).

According to yet another aspect of the invention, a system configured for fixed-pattern noise correction of at least one image is proposed, the system comprising:
at least one rotating image sensor arranged to acquire at least N substantially distinct and regular images, so that the combination of the distinct images forms a panorama of a surrounding scene, the fixed-pattern noise in each of the N acquired images being substantially identical,
a processing module arranged and/or programmed to determine at least one fixed-pattern noise correction parameter from the N images acquired by the image sensor, the at least one correction parameter minimizing a functional, and to correct the fixed-pattern noise in each of the N acquired images from said estimate of the at least one determined correction parameter.

According to another aspect of the invention, also proposed is a computer program product comprising instructions which, when the program is executed by a computer, cause the latter to implement the steps of the method according to the invention.

### DESCRIPTION OF THE FIGURES AND EMBODIMENTS

Other benefits and features of the invention shall become evident upon examining the detailed description of entirely non-limiting implementations and embodiments, and from the following enclosed drawings:

FIG. 1 is a schematic cross sectional profile view of a system according to the invention according to one embodiment.

FIG. 2 is a flowchart of the method of the invention according to one embodiment.

These embodiments are in no way limiting, and in particular, it is possible to consider variants of the invention that comprise only a selection of the features disclosed or shown hereinafter in isolation from the other features disclosed or shown (even if that selection is isolated within a phrase comprising other features), if this selection of features is sufficient to confer a technical benefit or to differentiate the invention with respect to the prior state of the art. This selection comprises at least one preferably functional feature which lacks structural details, and/or only has a portion of the structural details if that portion alone is sufficient to confer a technical benefit or to differentiate the invention with respect to the prior art.

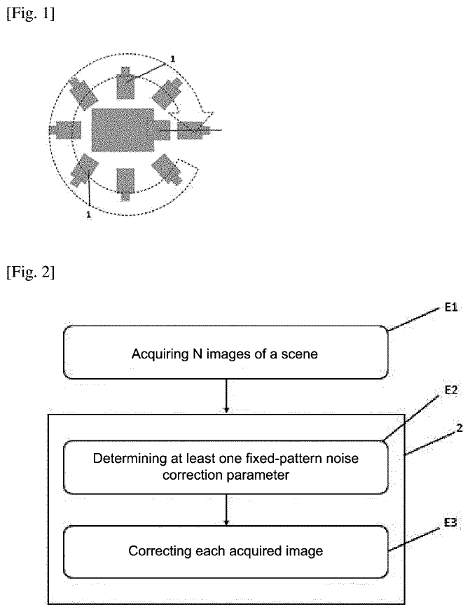

With reference to [FIG. 1], we will first describe a system configured for fixed-pattern noise correction of at least one image. The system comprises a rotating image sensor 1 arranged to acquire N substantially distinct and regular images, so that the combination of the distinct images forms a panorama of a surrounding scene, the fixed-pattern noise in each of the N acquired images being substantially identical. In another embodiment, the system can comprise several image sensors, whether rotating or not. The image sensor 1 is rotated to acquire several images of the environment following a panorama. The images acquired are distinct from one another, that is to say each image acquired images a sector of the panorama. In other embodiments, the images acquired may also include images of the same scene or images with a high degree of overlap with other images.

An image is defined as a set of pixel values measured when captured by an image sensor 1. A scene corresponds to a physical reality in front of the image sensor 1, which is captured by said image sensor 1 and imaged. When image sensor 1 rotates, it observes another scene. In a preferred embodiment, the rotating image sensor 1 is an infrared rotating image sensor 1. The image sensor is made up of a set of sensors, each corresponding to a pixel. Depending on the model, the infrared rotating image sensor 1 acquires multiple images to reconstruct a panorama. A panorama is therefore a set of scenes, or images, placed end-to-end to produce a 360-degree view, preferentially of at least 90 degrees. The rotating image sensor 1 rotates at a frequency typically between 2 Hz and 0.5 Hz. The image sensor 1 can be rotated clockwise and counter-clockwise. Preferentially, the rotating image sensor 1 acquires images at a minimum acquisition frequency F. F can take values such as 7.5 Hz, 45 Hz or 64 Hz. The invention can be applied to other systems that move or rotate the system at a sufficiently high frequency for several images to be acquired according to the embodiment shown.

The system also comprises a processing module (not shown in the figure) arranged and/or programmed to determine at least one fixed-pattern noise correction parameter from the N images acquired by the image sensor, the at least one correction parameter minimizing a functional, and to correct the fixed-pattern noise in each of the N acquired images from said estimate of the at least one determined correction parameter.

With reference to [FIG. 2], a flowchart of the method of the invention according to one embodiment will be described.

The method of correcting fixed-pattern noise in at least one image comprises three steps (E1 to E3). Step E1 corresponds to an acquisition by the image sensor 1 of N substantially distinct and regular images, so that the combination of the distinct images forms a panorama of a surrounding scene, the fixed-pattern noise in each of the N acquired images being substantially identical. Image acquisition is handled in the same way as shown [FIG. 1].

Step E2 corresponding to the determination of at least one correction parameter for correcting the fixed-pattern by means of a processing module 2 from the N acquired images, the at least one correction parameter minimizing a functional.

According to a first embodiment, the processing module 2 is configured to directly determine at least one fixed-pattern noise correction parameter by minimizing a functional. The processing module 2 is then configured to estimate a set of parameters for all of the N images acquired, the set of parameters comprising a gain value and an offset value.

The functional returns a number, often defined as positive, which is related to the amount of fixed-pattern noise present in the group of N acquired images under consideration. The aim is to reduce this value to eliminate the fixed-pattern noise. The functional varies according to the correction parameters defined (offset, gain, etc.). The value of the functional corresponds to the value of a function related to the amount of noise present in the image wherein these corrections are applied. The set of correction parameters determined by the processing module 2 minimizes this functional.

In practice, the functional is often composed of a data attachment term and a regularization term. The choice of the two terms reflects assumptions of regularity made about the scenes expected to be observed in practice. Here, a “total variation” term is used as the regularization term, and a quadratic penalty, on the norm of the estimated gains (minus one) and offsets corrections, as the data attachment. The regularization term, based on total variation, reflects the fact that the image ƒᵢ, after correction \hat{ƒ}ᵢ=G*ƒᵢ+0, should give an image with low total variation. The data attachment term reflects the fact that the intensities of the images ƒᵢ and \hat{ƒ}ᵢ must be close, so the gain must be close to 1 at each pixel and the offset close to 0. Correction parameters are thus applied to the image, in this case an offset parameter (of order 0) and a gain parameter (of order 1). The parameters that minimize said quantity are sought.

Here, several images are available (with image index i ranging from 1 to N), and a single set of gain and offset parameters is determined for all of the images (fixed-pattern noise is assumed to be fixed on this set of acquired images). The total variations are summed for the different images, as all images must have their discontinuities reduced by the correct fixed-pattern noise correction. Other aggregation methods could also be used, such as the minimum or median.

The following functional is then obtained:

$$E ( O , G ) = {\sum }_{i = 1}^{N} TV ( G * f + O ) + {‖ O ‖}_{ℱ}^{2} + {‖ G - \overline{1} ‖}_{ℱ}^{2}$$

The fixed-pattern noise varies slightly over time, so the corrective parameters are updated for a new group of images. In each case, the correction parameters are estimated from several images. A “new group” is understood to mean a batch of N images acquired during one rotation by the image sensor. Once the correction has been estimated for N images, it is assumed that, for the next N images, the fixed-pattern noise will have changed very little. This means that specific correction parameters can be distributed and adapted.

In this or other embodiments, in order to minimize the functional and obtain the correction parameters, several techniques can be used, for example:
an iterative optimization method,
a machine learning method, where a function is learned to directly produce a good approximation to the solution of the minimization functional. This function will take the N images as input and either return the correction parameters, or directly the corrected N images (in which case parameter estimation is considered implicit).

According to a second embodiment, the processing module 2 is configured to determine at least one fixed-pattern noise correction parameter from the N images acquired via a direct implementation.

This embodiment consists in taking each of the acquired images individually and applying processing equivalent to a high-pass filter to each of the N acquired images. More specifically, this high-pass filter consists in taking, for each pixel of the acquired image, the median value of its eight direct neighboring pixels and subtracting it from the value of the pixel in question. The result of the high-pass filter on each image contains several components, such as the natural difference of the scene content in each pixel with respect to its neighbors, and noise composed of a time-dependent component (fixed-pattern noise) and a time-independent component (photonic and electronic noise). In other embodiments, a certain number of other alternative filters are possible. For example, for the first determination step, it is possible to use subtraction of the neighbors' mean or subtraction of any other low-pass filter (which is equivalent to applying a high-pass filter). Machine learning can also be used to independently predict the correction at each pixel on each image.

According to the described embodiment, step E2 also comprises a step of filtering the N processed images to extract at least one correction parameter common to each of the N acquired images. Filtering allows the contribution of the observed scenes to be greatly reduced, which means that the scenes must correspond to a variety of scenes. This is the case here because, according to the invention, a rotating image sensor is used, with each image acquired covering a different angle of view and with little overlap with the previous image. The result of the high-pass filter processing step on each acquired image is then filtered to produce a single image, that is to say a single estimate at each pixel. More specifically, a median at each pixel of the set of images is produced, retrieved and used as a correction parameter. This second filtering operation has the effect of greatly reducing the contribution of time-independent noise and observed scenes at each pixel, while fixed-pattern noise is retained. The common correction parameter therefore corresponds to an estimate of the fixed-pattern noise present in the acquired images. In other embodiments, filters other than the one presented here are conceivable, such as averaging after removal of elements beyond the extreme quantiles, or filtering the value appearing the most.

This second filtering step is equivalent to seeking consensus between independent estimates of the correction parameters for each image.

If the number of images used is small and the frequency of variation of non-uniformity is sufficiently slow, temporal smoothing of the at least one common correction parameter is used to refine the results of the at least one common correction parameter.

Method step E3 corresponds to correcting the fixed-pattern noise in each of the N images acquired by the processing module using the at least one determined fixed-pattern noise correction parameter.

The correction is applied in the same way in all cases. This involves applying the correction parameter(s) determined to the N images, that is to say multiplying each image by the gain and adding the offset determined. The correction can be applied following a factory-preset image sensor calibration, for example.

Typically at least one of the means of the device according to the invention previously described, preferably each of the means of the device according to the invention previously described, is a technical means.

Typically, each means of the device according to the invention previously disclosed comprises at least one computer, a central processing or computing unit, an analog electronic circuit (preferably dedicated), a digital electronic circuit (preferably dedicated), and/or a microprocessor (preferably dedicated), and/or software means.

Of course, the invention is not limited to the examples just described, and many adjustments can be made to these examples without going beyond the scope of the invention.

Of course, the various embodiments, features, forms and variants of the invention may be combined with one another in various combinations as long as they are not incompatible or exclusive of each other.

1. A method for correcting fixed-pattern noise in at least one image, the method comprising the following steps:
acquiring at least N substantially distinct and regular images by means of at least one rotating image sensor such that the combination of the N images forms a panorama of a surrounding scene, the fixed-pattern noise in each of the N acquired images being substantially the same;
determining at least one correction parameter for correcting the fixed-pattern noise by means of a processing module from the at least N acquired images, the at least one correction parameter minimizing a functional; and
correcting the fixed-pattern noise in each of the N images acquired by the processing module using the at least one determined fixed-pattern noise correction parameter.

2. The method according to claim 1, characterized in that the step of determining at least one fixed-pattern noise correction parameter by means of the processing module comprises the following step:
determining a set of at least two correction parameters for the set of N images acquired by the processing module, the set of correction parameters comprising a gain value and an offset value.

3. The method according to claim 1, characterized in that the step of determining at least one fixed-pattern noise correction parameter by means of the processing module is carried out via a direct implementation.

4. The method according to claim 3, characterized in that the direct implementation comprises the following steps:
first filtering of the N images; and
second filtering along the N images.

5. The method according to claim 4, characterized in that the first filtering of the N images comprises the use of a high-pass filter.

6. The method according to claim 1, characterized in that the step of determining at least one fixed-pattern noise correction parameter by means of the processing module also comprises the following step:
temporal smoothing of the at least one correction parameter common to each of the N images acquired.

7. A system configured for fixed-pattern noise correction of at least one image, the system comprising:
at least one rotating image sensor arranged to acquire at least N substantially distinct and regular images, so that the combination of the distinct images forms a panorama of a surrounding scene, the fixed-pattern noise in each of the N acquired images being substantially identical; and
a processing module arranged and/or programmed to determine at least one fixed-pattern noise correction parameter from the N images acquired by the image sensor, the at least one correction parameter minimizing a functional, and to correct the fixed-pattern noise in each of the N acquired images from said estimate of the at least one determined correction parameter.

8. A computer program product comprising instructions which, when the program is executed by a computer, cause the latter to implement the steps of the method according to claim 1.
